(19) United States
(12) Patent Application Publication
(10) Pub. No.: US 2025/0370371 A1
(43) Pub. Date: Dec. 4, 2025

(54) EXPOSURE HEAD AND IMAGE FORMING APPARATUS INCLUDING THE EXPOSURE HEAD

(71) Applicant: CANON KABUSHIKI KAISHA, Tokyo (JP)

(72) Inventor: TETSURO YASUKAWA, Chiba (JP)

(21) Appl. No.: 19/214,922

(22) Filed: May 21, 2025

(30) Foreign Application Priority Data
May 30, 2024 (JP) 2024-088425

(51) Int. Cl. G03G 15/043; G03G 15/00

(52) U.S. Cl. CPC G03G 15/043; G03G 15/80; G03G 2215/0412

(57) ABSTRACT

When mounting a plurality of light emitting chips on a substrate, there is a risk that adhesive protruding from a light emitting chip comes into contact with an adjacent light emitting chip and affects mounting position accuracy of the light emitting chip with respect to the substrate. The adhesive that bonds the substrate and the light emitting chip includes a protruding area that does not overlap with the light emitting chip, viewed from a direction perpendicular to a surface of the substrate. The protruding area includes a first protruding area located on one side and a second protruding area located on the other side with respect to the light emitting chip in a transverse direction of the substrate. The first protruding area may be larger than the second protruding area.

### BACKGROUND

### Field

The present disclosure relates to an exposure head and an image forming apparatus including the exposure head.

### Related Art

In electrophotographic printers, a method is generally known in which a photosensitive drum is exposed to light using an exposure head equipped with light emitting elements such as light emitting diodes (LEDs) or organic electroluminescence (EL) elements to form a latent image. Some of the exposure heads include light emitting chips with a plurality of light emitting elements arranged along a direction of a rotation axis of a photosensitive member and are mounted on a substrate in a staggered pattern (Japanese Patent Application Laid-Open No. 2004-167872).

### SUMMARY

The present disclosure is directed to reducing a risk of a decrease in accuracy of a mounting position of a light emitting chip on a substrate in an image forming apparatus as described above.

An aspect of the present disclosure provides an exposure head including a light emitting chip including a plurality of light emitting elements configured to emit light for exposing a photosensitive member and arranged along a direction of a rotation axis of the photosensitive member; a substrate configured to mount the light emitting elements; and an adhesive configured to bond the substrate and the light emitting chip. With the adhesive applied to a surface of the substrate, a protruding area of the adhesive does not overlap with the light emitting chip, viewed from a direction perpendicular to the surface of the substrate. The protruding area includes a first protruding area located on one side of the light emitting chip and a second protruding area located on an opposite side of the light emitting chip in a transverse direction of the substrate. The first protruding area is larger than the second protruding area.

Further features of the present disclosure will become apparent from the following description of exemplary embodiments with reference to the attached drawings.

### BRIEF DESCRIPTION OF THE DRAWINGS

FIG. 1 is a configuration diagram illustrating a schematic configuration of an image forming apparatus according to an exemplary embodiment.

FIGS. 2A and 2B illustrate configurations of a photosensitive member and an exposure head according to the exemplary embodiment.

FIGS. 3A and 3B illustrate a configuration of a printed substrate of the exposure head according to the exemplary embodiment.

FIG. 4 illustrates light emitting chips and light emitting element arrays in the light emitting chips according to the exemplary embodiment.

FIG. 5 is a plan view illustrating a schematic configuration of the light emitting chip according to the exemplary embodiment.

FIG. 6 is a cross-sectional view of the schematic configuration of the light emitting chip according to the exemplary embodiment.

FIG. 7 is a circuit diagram illustrating a control configuration of an exposure apparatus according to the exemplary embodiment.

FIG. 8 is a signal chart related to access to a register of the light emitting chip according to the exemplary embodiment.

FIG. 9 is a signal chart related to transmission of image data to the light emitting chip according to the exemplary embodiment.

FIG. 10 is a functional block diagram illustrating a detailed configuration of the light emitting chip according to the exemplary embodiment.

FIG. 11 illustrates multiple exposure using light emitting elements arranged in a staircase pattern.

FIG. 12A illustrates light emission control based on input image data.

FIG. 12B illustrates light emission control based on input image data.

FIG. 12C illustrates light emission control based on input image data.

FIG. 12D illustrates light emission control based on input image data.

FIG. 13 is a plan view illustrating a schematic configuration of attaching the light emitting chip to the printed substrate according to an exemplary embodiment.

FIG. 14 is a plan view schematically illustrating deviation in accuracy in attaching the light emitting chip to the printed substrate according to the exemplary embodiment.

FIG. 15A is a plan view illustrating a die bonding process according to the exemplary embodiment.

FIG. 15B is a plan view illustrating the die bonding process according to the exemplary embodiment.

FIG. 15C is a plan view illustrating the die bonding process according to the exemplary embodiment.

FIG. 15D is a plan view illustrating the die bonding process according to the exemplary embodiment.

FIG. 15E is a plan view illustrating the die bonding process according to the exemplary embodiment.

FIG. 15F is a plan view illustrating the die bonding process according to the exemplary embodiment.

FIG. 16 is a cross-sectional view illustrating the die bonding process according to the exemplary embodiment.

FIG. 17A is a plan view illustrating a die bonding process in a case where an amount of applied adhesive is small according to the exemplary embodiment.

FIG. 17B is a plan view illustrating the die bonding process in a case where an amount of applied adhesive is small according to the exemplary embodiment.

FIG. 18 is a plan view illustrating a die bonding process according to the exemplary embodiment.

FIG. 19 is a cross-sectional view illustrating a die bonding process according to the exemplary embodiment.

### DESCRIPTION OF THE EMBODIMENTS

Exemplary embodiments of the present disclosure will be described in detail below with reference to the attached drawings. The exemplary embodiments described below do not restrict the present disclosure or the claims. A plurality of features are described in the exemplary embodiments, but not all of these features are essential to the present disclosure, and the plurality of features may be combined. The same or similar configurations in the attached drawings are denoted by the same reference numerals, and redundant description are not repeated, for clarity.

### 1. Schematic Configuration of Image Forming Apparatus

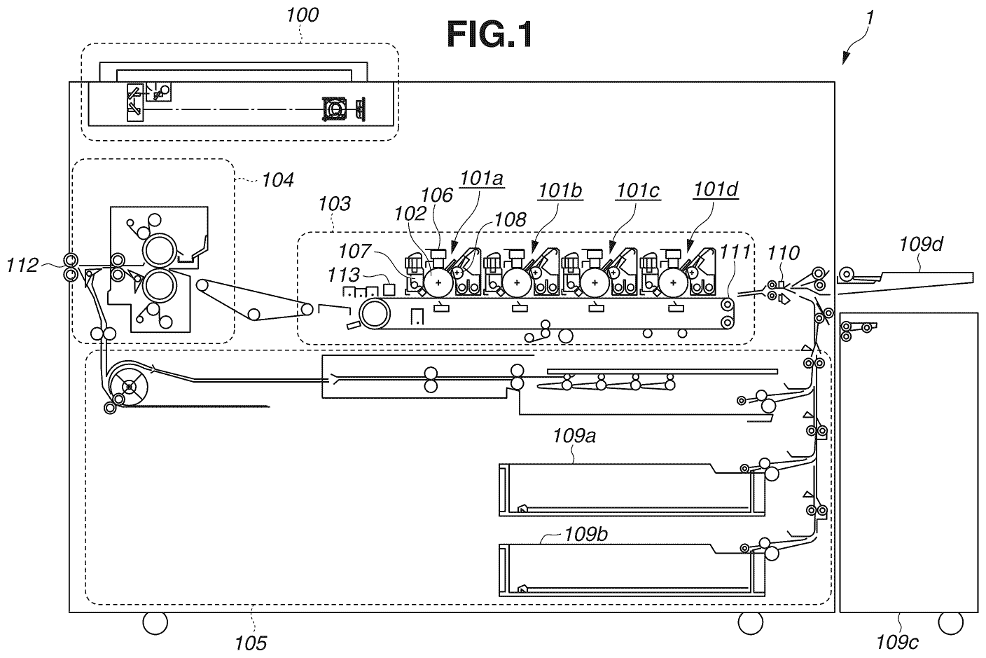

FIG. 1 illustrates an example of a schematic configuration of an image forming apparatus 1 according to an exemplary embodiment. The image forming apparatus 1 includes a reading unit 100, an image forming unit 103, a fixing unit 104, and a conveyance unit 105. The reading unit 100 optically reads a document placed on a document platen and generates read image data. The image forming unit 103 forms an image on a sheet, for example, based on the read image data generated by the reading unit 100 or based on image data for printing received from an external apparatus via a network.

The image forming unit 103 includes image forming units 101a, 101b, 101c, and 101d. The image forming units 101a, 101b, 101c, and 101d respectively form black, yellow, magenta, and cyan toner images. The image forming units 101a, 101b, 101c, and 101d have the same configuration and may also be collectively referred to as the image forming unit 101 herein. A photosensitive member 102 of the image forming unit 101 is driven to rotate in a clockwise direction in FIG. 1 during image formation. A charger 107 charges the photosensitive member 102. An exposure head 106 exposes the photosensitive member 102 to light to form an electrostatic latent image on a surface of the photosensitive member 102. A developing device 108 develops the electrostatic latent image on the photosensitive member 102 with toner to form a toner image. The toner image formed on the surface of the photosensitive member 102 is transferred to a sheet conveyed on a transfer belt 111. The toner images on the four photosensitive members 102 are superimposed and transferred onto the sheet, so that a color image containing four color components, black, yellow, magenta, and cyan can be formed.

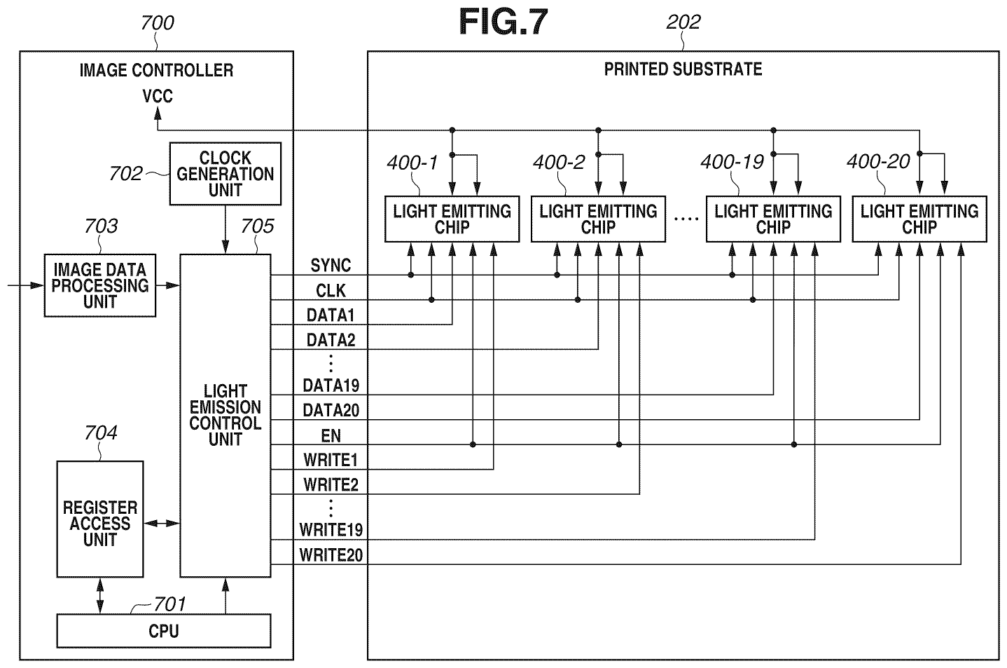

The conveyance unit 105 controls feed and conveyance of a sheet. Specifically, the conveyance unit 105 feeds a sheet from a unit specified from among internal storage units 109a and 109b, an external storage unit 109c, and a manual feeding unit 109d to a conveyance path of the image forming apparatus 1. The sheet that is fed is conveyed to a registration roller 110. The registration roller 110 conveys the sheet onto to the transfer belt 111 at an appropriate timing so that the toner image on each photosensitive member 102 is transferred onto the sheet. As described above, while the sheet is conveyed on the transfer belt 111, the toner images are transferred to the sheet. The fixing unit 104 applies heat and pressure to the sheet on which the toner images are transferred to fix the toner images to the sheet. After fixing the toner images, the sheet is discharged to the outside of the image forming apparatus 1 by a discharging roller 112. An optical sensor 113 is arranged at a position facing the transfer belt 111. The optical sensor 113 optically reads a test chart, which is formed on the transfer belt 111 by the image forming unit 101. In a case where a positional deviation is detected in the test chart read by the optical sensor 113, an image controller 700 (FIG. 7), which is described below, performs control to compensate for the positional deviation at a time of executing a subsequent job.

An example is described here in which the toner image is directly transferred from each photosensitive member 102 to the sheet on the transfer belt 111, but the toner image may be indirectly transferred from each photosensitive member 102 to the sheet via an intermediate transfer member. Also described is an example in which a color image is formed using toners of a plurality of colors, but the technique according to the present disclosure can also be applied to an image forming apparatus that forms a monochromatic image using toner of a single color.

### 2. Configuration Example of Exposure Head

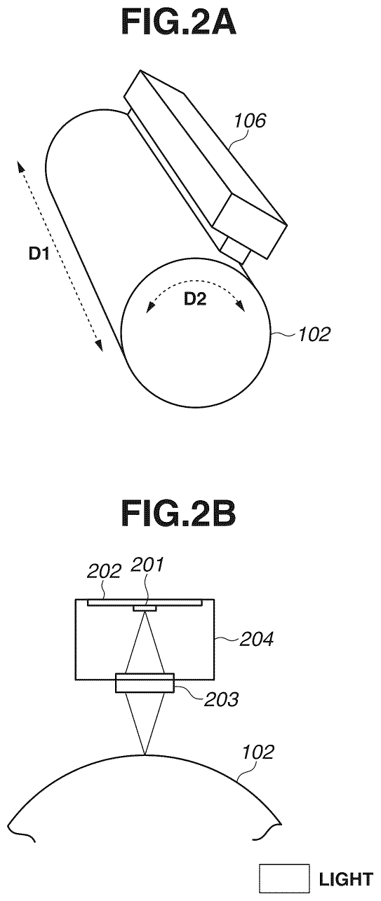

FIGS. 2A and 2B illustrate the photosensitive member 102 and the exposure head 106. The exposure head 106 includes a light emitting element array 201, a long printed substrate 202 on which the light emitting element array 201 is mounted, a rod lens array 203, and a housing 204 that stores the rod lens array 203 and the printed substrate 202. The photosensitive member 102 has a cylindrical shape. The exposure head 106 is arranged so that its longitudinal direction is parallel to an axial direction D1 of the photosensitive member 102 and a surface on which the rod lens array 203 is attached faces the surface of the photosensitive member 102. While the photosensitive member 102 rotates in a circumferential direction D2, the light emitting element array 201 of the exposure head 106 emits light, and the rod lens array 203 focuses the light on the surface of the photosensitive member 102.

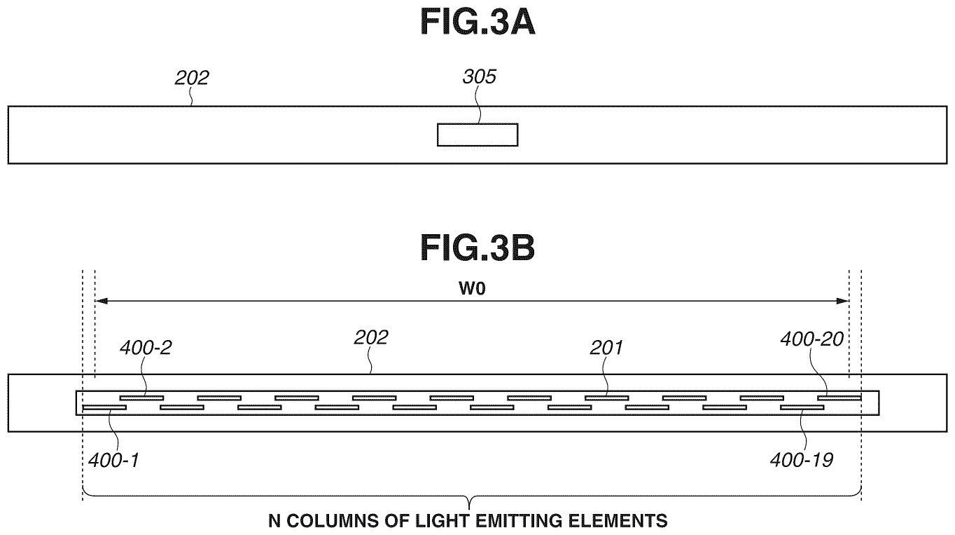

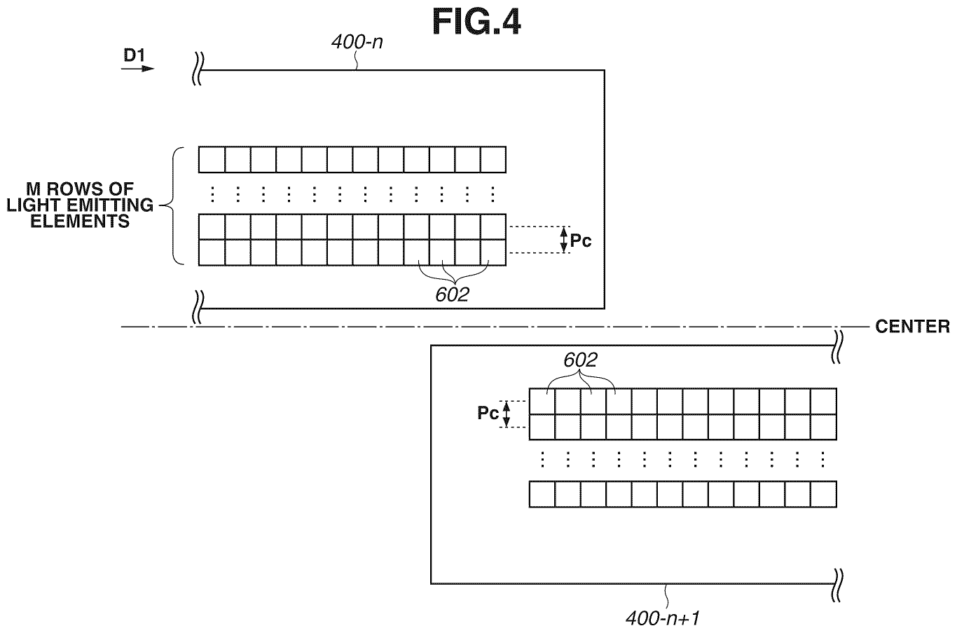

FIGS. 3A and 3B illustrate an example configuration of the printed substrate 202. FIG. 3A illustrates a surface on which a connector 305 is mounted, and FIG. 3B illustrates a surface on which the light emitting element array 201 is mounted, i.e. on the surface opposite to the surface on which the connector 305 is mounted. FIG. 4 schematically illustrates a light emitting chip 400 and an array of light emitting elements 602 in the light emitting chip 400.

According to the present exemplary embodiment, the light emitting element array 201 includes a plurality of light emitting elements arranged two-dimensionally. The light emitting element array 201 generally includes N columns of light emitting elements in the axial direction D1 and M rows of light emitting elements in the circumferential direction D2 of the photosensitive member, where M and N are integers greater than or equal to two. In the example in FIG. 3B, the light emitting element array 201 is divided into 20 light emitting chips 400-1 to 400-20, each of which includes a subset of an entirety of the plurality of light emitting elements, and the light emitting chips 400-1 to 400-20 are arranged in a staggered pattern along the axial direction D1. The light emitting chips 400-1 to 400-20 may also be collectively referred to as the light emitting chip 400. As illustrated in FIG. 3B, a range occupied by all the light emitting elements of the 20 light emitting chips in the axial direction D1 is wider than a range occupied by a maximum width Wo of input image data. Thus, some light emitting elements located at both ends in the axial direction D1 may not be used to expose the photosensitive member 102 to light unless a positional deviation of an image is detected. Each light emitting chip 400 on the printed substrate 202 is connected to the image controller 700 (FIG. 7) via the connector 305. In the following description, a side with a smaller number of the light emitting chips 400-1 to 400-20 aligned along the axial direction D1 may be referred to as “left” and a side with the larger number as “right”, for the convenience of explanation. For example, the light emitting chip 400-1 is the leftmost light emitting chip 400, and the light emitting chip 400-20 is the rightmost light emitting chip 400.

The number J (J=N/20) of the light emitting elements 602 arranged in each row of one emitting chip 400 may be equal to, for example, 748 (J=748). On the other hand, an M number of the light emitting elements 602 arranged in each column of one light emitting chip 400 may be equal to, for example, 4 (M=4). In other words, according to the exemplary embodiment, each light emitting chip 400 may include a total of 2992 (=748*4) light emitting elements 602. That is, 748 elements may be arranged in the axial direction D1, with 4 sets of elements spaced apart in the circumferential direction D2. A distance Pc between center points of the light emitting elements 602 adjacent to each other in the circumferential direction D2 may be, for example, about 21.16 μm, which corresponds to a resolution of 1200 dpi. A distance between the center points of the light emitting elements 602 adjacent to each other in the axial direction D1 may also be about 21.16 μm, and in this case, the 748 light emitting elements 602 occupy a length of about 15.8 mm in the axial direction D1. FIG. 4 illustrates an example in which the light emitting elements 602 are arranged in a grid pattern in each light emitting chip 400 for the convenience of explanation. However, in practice, the M (M=4) light emitting elements 602 in each column are arranged in a staircase pattern, as further described below.

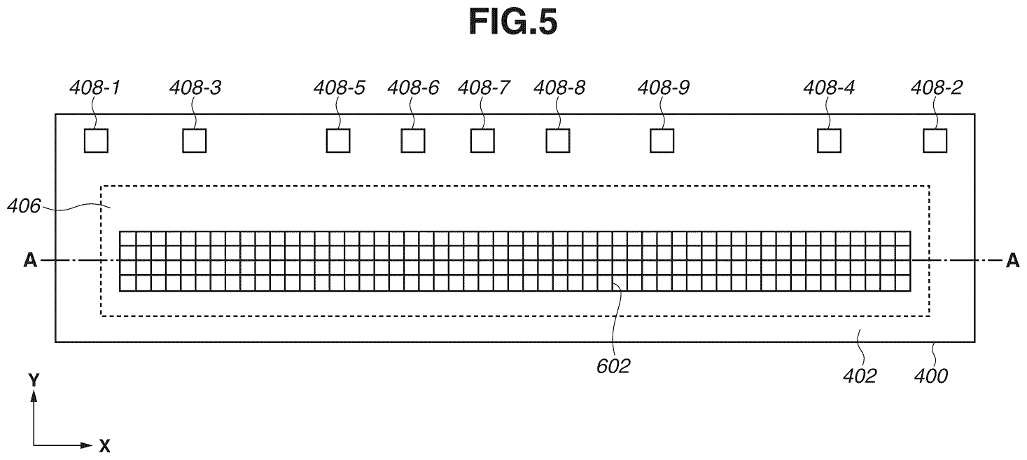

FIG. 5 is a plan view illustrating a schematic configuration of the light emitting chip 400. The plurality of light emitting elements 602 of each light emitting chip 400 is formed on, for example, a light emitting substrate 402, which is a silicon substrate. The light emitting substrate 402 is provided with a circuit unit 406 that drives the plurality of light emitting elements 602. Signal lines for communicating with the image controller 700, power supply lines for connecting to a power supply, and ground lines for connecting to a ground are connected to pads 408-1 to 408-9. The signal lines, power supply lines, and ground lines may be wires that are made of, for example, gold.

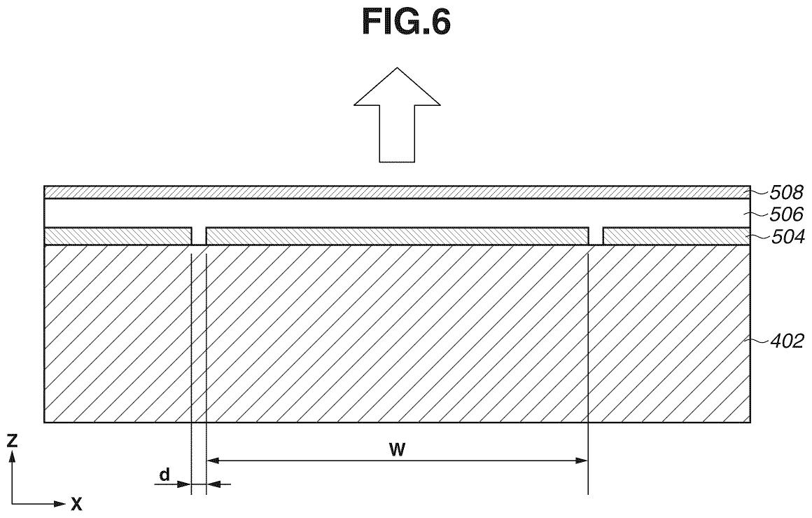

FIG. 6 illustrates a part of a cross section along a line A-A in FIG. 5. A plurality of lower electrodes 504 is formed on the light emitting substrate 402. A gap of length d is provided between adjacent lower electrodes 504. A light emitting layer 506 is provided on the lower electrode 504, and an upper electrode 508 is provided on the light emitting layer 506. The upper electrode 508 is a common electrode for the plurality of lower electrodes 504. If a voltage is applied between the lower electrode 504 and the upper electrode 508, a current flows from the lower electrode 504 to the upper electrode 508, and the light emitting layer 506 emits light. Thus, one light emitting element 602 is configured with one lower electrode 504 and partial areas of the light emitting layer 506 and the upper electrode 508 corresponding to the lower electrode 504. In other words, according to the present exemplary embodiment, the light emitting substrate 402 includes the plurality of light emitting elements 602.

For the light emitting layer 506, for example, an organic electroluminescence (EL) film can be used. The upper electrode 508 is configured with a transparent electrode made of indium tin oxide (ITO) or the like in order to transmit light having an emission wavelength of the light emitting layer 506. According to the present exemplary embodiment, the entire upper electrode 508 is transparent to the emission wavelength of the light emitting layer 506. The entire upper electrode 508 need not be transparent to the emission wavelength. Rather, it is sufficient that the partial area through which the light from each light emitting element 602 passes is transparent to the emission wavelength. In FIG. 6, one continuous light emitting layer 506 is formed, but a plurality of light emitting layers 506 having a width equal to a width W of the lower electrode 504 may each be formed on the corresponding lower electrode 504. In FIG. 6, the upper electrode 508 is the common electrode for the plurality of lower electrodes 504. A plurality of upper electrodes 508 having a width equal to the width W of the lower electrode 504 may each be formed above the corresponding one of a plurality of lower electrodes 504. Among the lower electrodes 504 of each light emitting chip 400, a plurality of first lower electrodes 504 may be covered with a first light emitting layer 506, and a plurality of second lower electrodes 504 may be covered with a second light emitting layer 506. Among the lower electrodes 504 of each light emitting chip 400, a first upper electrode 508 may be commonly formed corresponding to the plurality of first lower electrodes 504, and a second upper electrode 508 may be commonly formed corresponding to the plurality of second lower electrodes 504. In these configurations, one light emitting element 602 is configured with one lower electrode 504 and areas of the light emitting layer 506 and the upper electrode 508 corresponding to the lower electrode 504.

FIG. 7 is a circuit diagram related to a control configuration for controlling the light emitting chip 400. The image controller 700 is a control circuit that communicates with the printed substrate 202 via a plurality of signal lines (wires). The image controller 700 includes a central processing unit (CPU) 701, a clock generation unit 702, an image data processing unit 703, a register access unit 704, and a light emission control unit 705. The light emission control unit 705 is a component that forms an exposure apparatus together with the exposure head 106. The light emission control unit 705 terminates the signal lines between the printed substrate 202 and itself. The n-th light emitting chip 400-n (n is an integer from 1 to 20) on the printed substrate 202 is connected to the light emission control unit 705 via a signal line DATAn and a signal line WRITEn. The signal line DATAn is used to transmit image data from the image controller 700 to the light emitting chip 400-n.

The signal line WRITEn is used by the image controller 700 to write control data to a register of the light emitting chip 400-n.

One signal line CLK, one signal line SYNC, and one signal line EN are provided between the light emission control unit 705 and each light emitting chip 400. The signal line CLK is used to transmit a clock signal for transmitting data using the signal lines DATAn and WRITEn. The light emission control unit 705 outputs a clock signal generated based on a reference clock signal from the clock generation unit 702 to the signal line CLK. Signals to be transmitted to the signal line SYNC and the signal line EN are described below.

The CPU 701 controls the image forming apparatus 1. The image data processing unit 703 performs image processing on image data received from the reading unit 100 or an external apparatus to generate image data in a binary bitmap format for controlling on/off of light emission of the light emitting elements 602 of the light emitting chip 400 on the printed substrate 202. The image processing can include, for example, raster conversion, gradation correction, color conversion, and halftone processing. The image data processing unit 703 transmits the generated image data to the light emission control unit 705 as input image data. The register access unit 704 receives control data to be written to the register in each light emitting chip 400 from the CPU 701 and transmits it to the light emission control unit 705.

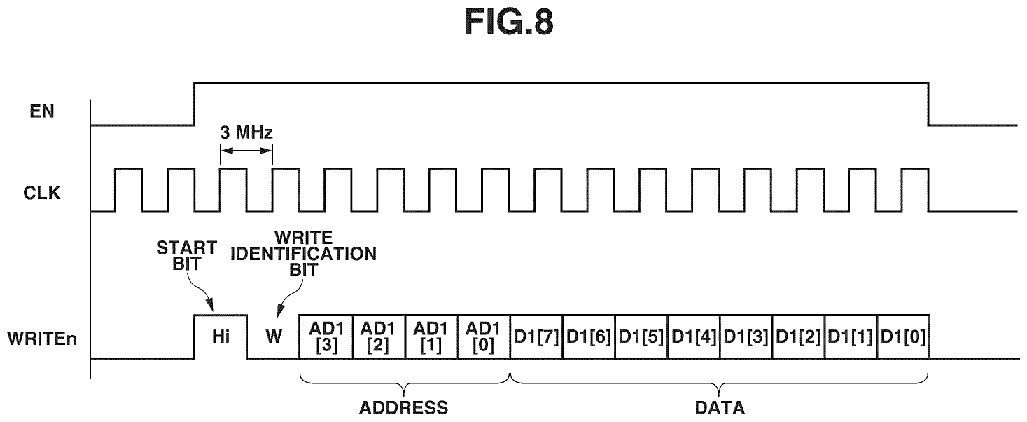

FIG. 8 illustrates transition of a signal level of each signal line in a case where control data is written to the register of the light emitting chip 400. An enable signal, which is at a high level during communication to indicate that communication is in progress, is output to the signal line EN. The light emission control unit 705 transmits a start bit to the signal line WRITEn in synchronization with rising of the enable signal. Subsequently, the light emission control unit 705 transmits a write identification bit indicating that it is a write operation and then transmits an address (four bits in this example) of the register to which the control data is written and the control data (eight bits in this example). In writing to the register, for example, the light emission control unit 705 sets a frequency of the clock signal to be transmitted to the signal line CLK to 3 MHz.

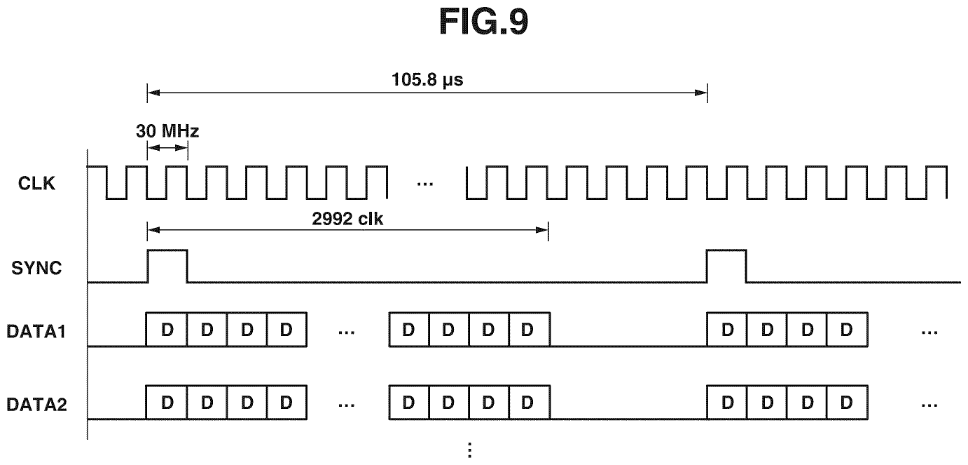

FIG. 9 illustrates transition of a signal level of each signal line in a case where image data is transmitted to each light emitting chip 400. A periodic line synchronization signal indicating an exposure timing of each line of the photosensitive member 102 is output to the signal line SYNC. If a peripheral speed of the photosensitive member 102 is 200 mm/s and a resolution in the circumferential direction is 1200 dpi (about 21.16 μm), a line synchronization signal is output at a period of about 105.8 μs. The light emission control unit 705 transmits the image data to the signal lines DATA1 to DATA20 in synchronization with rising of the line synchronization signal. According to the present exemplary embodiment, each light emitting chip 400 includes 2992 light emitting elements 602, to transmit image data indicating light emission/non-emission of each of 2992 light emitting elements 602 to each light emitting chip 400 within the period of about 105.8 μs. Thus, in this example, in transmitting image data, the light emission control unit 705 sets the frequency of the clock signal to be transmitted to the signal line CLK to 30 MHz, as illustrated in FIG. 9.

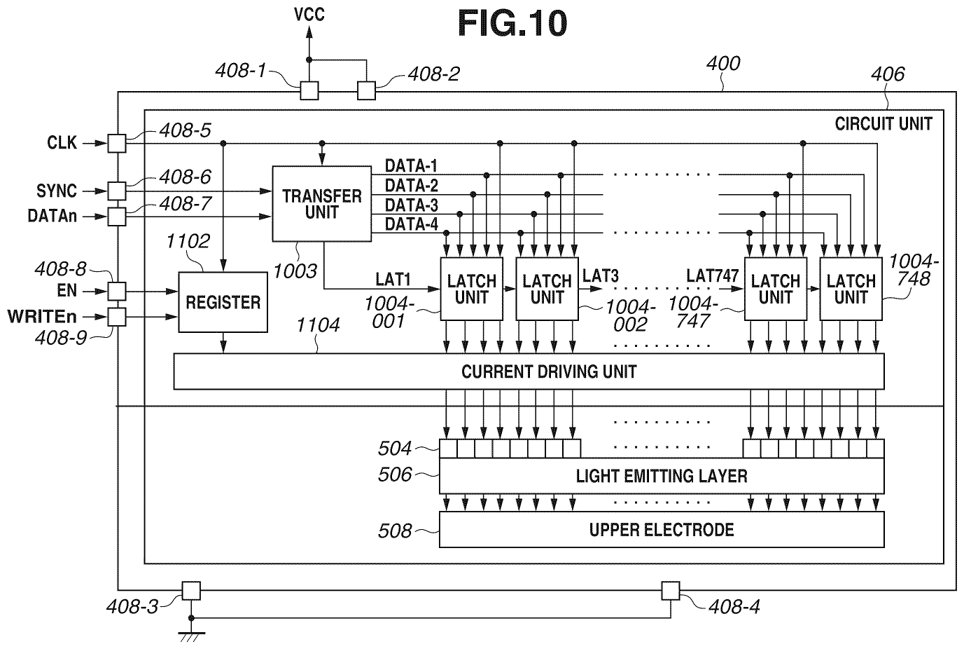

FIG. 10 is a functional block diagram illustrating a detailed configuration of one light emitting chip 400 (the n-th light emitting chip 400-n). As illustrated in FIG. 5, the light emitting chip 400 may include nine pads 408-1 to 408-9. The pads 408-1 and 408-2 are connected to a power supply voltage VCC by the power supply lines. Each circuit of the circuit unit 406 of the light emitting chip 400 is supplied with power by the power supply voltage VCC. The pads 408-3 and 408-4 are connected to the ground by the ground lines. Each circuit of the circuit unit 406 and the upper electrode 508 are connected to the ground via the pads 408-3 and 408-4. The signal line CLK is connected to a transfer unit 1003, a register 1102, and latch units 1004-001 to 1004-748 via the pad 408-5. The signal lines SYNC and DATAn are connected to the transfer unit 1003 via the pads 408-6 and 408-7. The signal lines EN and WRITEn are connected to the register 1102 via the pads 408-8 and 408-9. The register 1102 stores, for example, control data indicating desired emission intensity of the light emitting elements 602.

The transfer unit 1003 receives, from the signal line DATAn, input image data including a series of pixel values each indicating light emission/non-emission of one light emitting element 602 in synchronization with the clock signal from the signal line CLK, starting from the line synchronization signal from the signal line SYNC. The transfer unit 1003 performs serial-to-parallel conversion on the series of pixel values serially received from the signal line DATAn in units of M pixel values (for example, M=4). For example, the transfer unit 1003 includes four D flip-flops connected in cascade, parallelizes pixel values DATA-1, DATA-2, DATA-3, and DATA-4 that are input over four clocks, and outputs them to the latch units 1004-001 to 1004-748. The transfer unit 1003 further includes four D flip-flops for delaying the line synchronization signal and outputs a first latch signal to the latch unit 1004-001 via a signal line LAT1 at a timing delayed by four clocks after the line synchronization signal is input.

A k-th latch unit 1004-k (k is an integer from 1 to 748) stores the four pixel values DATA-1, DATA-2, DATA-3, and DATA-4 that are input from the transfer unit 1003 simultaneously with input of a k-th latch signal in a latch circuit. Further, except for the latch unit 1004-748 at the last stage, the k-th latch unit 1004-k delays the k-th latch signal by four clocks and outputs the (k+1)-th latch signal to the latch unit 1004-(k+1) via the signal line LAT(k+1). Then, the k-th latch unit 1004-k continues to output to a current driving unit 1104 a driving signal based on the four pixel values stored by the latch circuit during a signal period of the k-th latch signal. For example, there is a delay of four clocks between a timing when the first latch signal is input to the latch unit 1004-001 and a timing when the second latch signal is input to the latch unit 1004-002. Thus, the latch unit 1004-001 outputs driving signals based on the first, second, third, and fourth pixel values to the current driving unit 1104, while the latch unit 1004-002 outputs driving signals based on the fifth, sixth, seventh, and eighth pixel values to the current driving unit 1104. Generally, the latch unit 1004-k outputs driving signals based on the (4k−3), (4k−2), (4k−1) and (4k)-th pixel values to the current driving unit 1104. Therefore, according to the exemplary embodiment illustrated in FIG. 10, the 748 latch units 1004-001 to 1004-748 output, to the current driving unit 1104, 2992 driving signals for controlling driving of the 2992 (=748*4) light emitting elements 602 in substantially parallel. Each driving signal is a binary signal indicating a high or low level.

The current driving unit 1104 includes 2992 light emitting drive circuits each corresponding to the 2992 light emitting elements 602 each including the partial area of the light emitting layer 506. Each light emitting drive circuit applies a drive voltage corresponding to the emission intensity indicated by the control data in the register 1102 to the light emitting layer 506 of the corresponding light emitting element 602 while the corresponding driving signal indicates the high level indicating that light emission is on. Accordingly, a current flows through the light emitting layer 506, and the light emitting elements 602 emit light. The control data may indicate one individual emission intensity for each light emitting element 602, one emission intensity for each group of the light emitting elements 602, or one emission intensity common to all the light emitting elements 602.

### 3. Control of Multiple Exposure

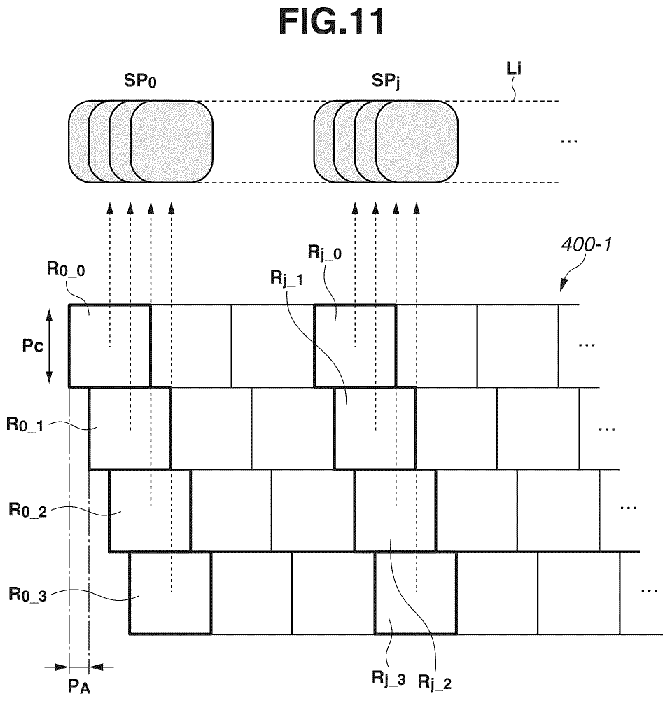

FIG. 4 illustrates the example in which the light emitting elements 602 are arranged in the grid pattern in each light emitting chip 400. In practice, according to the present exemplary embodiment, the M light emitting elements 602 in each column can be arranged in a staircase pattern at a constant pitch. FIG. 11 illustrates multiple exposure using the light emitting elements arranged in a staircase pattern. Here, an example of the arrangement of the light emitting elements in the light emitting chip 400-1 in a case where M=4 is partially illustrated. In FIG. 11, R_{j_m}(j={0, 1, . . . , J−1}, m={0, 1, 2, 3}) represents the light emitting element 602 in a j-th column from the left in the axial direction and an m-th row from the top in the circumferential direction. A pitch Pc of the light emitting elements in the circumferential direction may be about 21.16 um, as described above. A distance in the axial direction between two adjacent light emitting elements among the M light emitting elements in each column, namely a pitch PA of the light emitting elements in the axial direction may be about 5 um that corresponds to a resolution of 4800 dpi.

The four light emitting elements in each column are arranged in the staircase pattern in this way, so that any two adjacent light emitting elements in the four light emitting elements occupy areas that partially overlap in the axial direction. Then, the four light emitting elements in the column corresponding to each pixel position of the input image data sequentially emit light while the photosensitive member 102 rotates. Thus, a spot corresponding to each pixel position is formed on the surface of the photosensitive member 102. In the example in FIG. 11, in a case where a pixel value of the left end of an i-th line of the input image data indicates that the light emission is on, the light emitting elements R_{0_0}, R_{0_1}, R_{0_2}, and R_{0_3} sequentially emit light at a timing when each facing a line Lᵢ on the surface of the photosensitive member 102. As a result, a spot area at the left end of the line Lᵢ is multiplexly exposed to light to form a corresponding spot SP₀. Similarly, in a case where a j-th pixel value from the left in the i-th line of the input image data indicates that the light emission is on, the light emitting elements R_{j_o}, R_{j_1}, R_{j_2}, and R_{j_3} sequentially emit light at a timing when each facing the line Lᵢ on the surface of the photosensitive member 102. As a result, a j-th spot area from the left of the line Lᵢ is multiplexly exposed to light to form a corresponding spot SPⱼ.

As can be understood from FIG. 11, according to the present exemplary embodiment, the light emitting elements in two columns adjacent to each other in the axial direction also occupy areas that partially overlap in the axial direction. Similarly, among the two light emitting chips 400 adjacent to each other in the axial direction, the light emitting elements in the rightmost column of the left light emitting chip 400 and the light emitting elements in the leftmost column of the right light emitting chip 400 also occupy areas that partially overlap in the axial direction. The pitch PA of the light emitting elements in the axial direction is constant at about 5 um over all the 20 light emitting chips 400. The four light emitting elements in each column of these light emitting chips 400 sequentially emit light at appropriate timings, so that a smooth line of an electrostatic latent image formed with a series of spots that partially overlap each other with a constant spot spacing can be formed on the surface of the photosensitive member 102. Then, as a result of these lines being continuously formed in the circumferential direction, a two-dimensional electrostatic latent image is generated

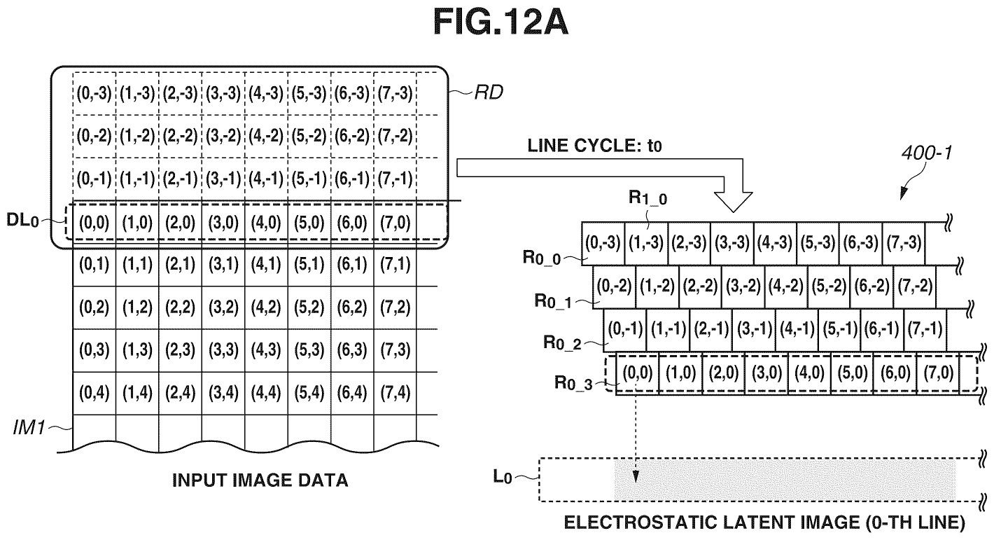

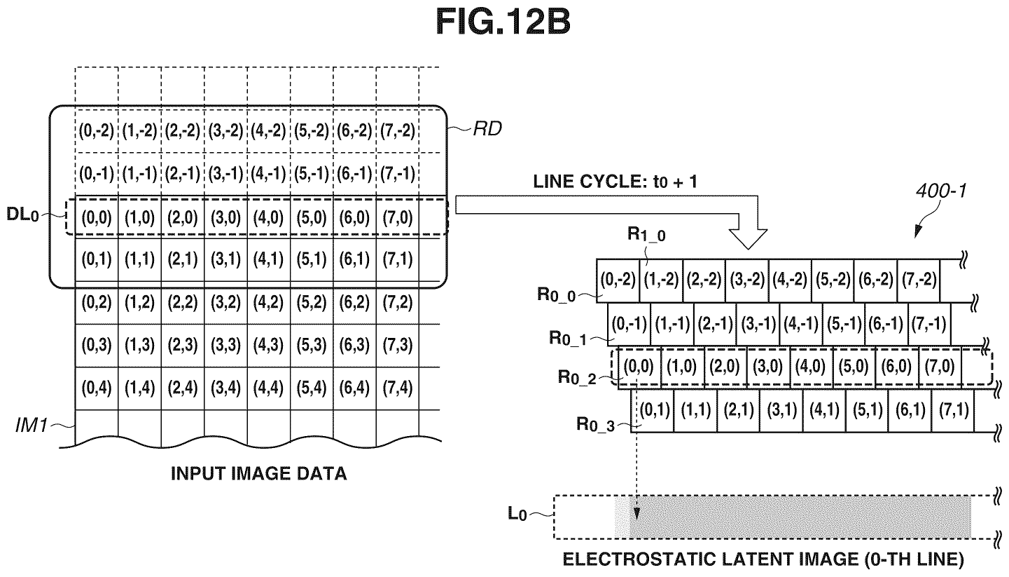

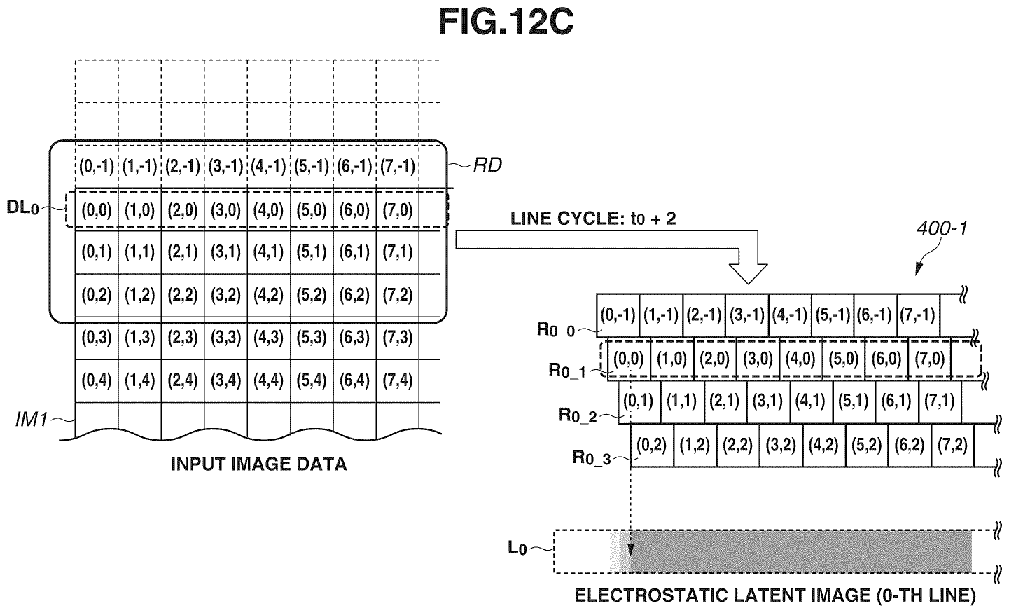

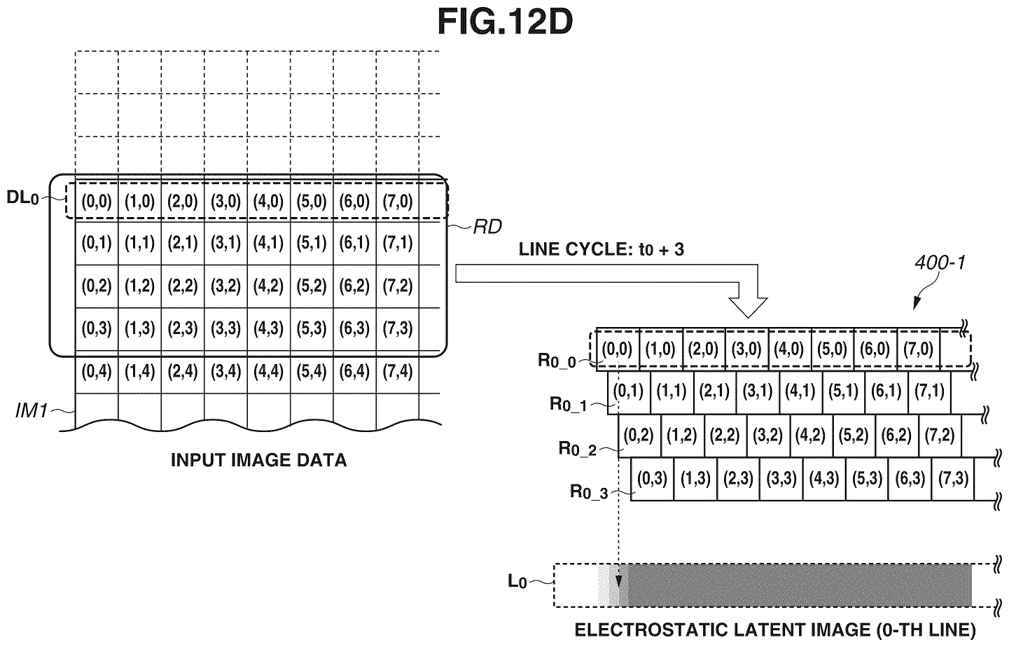

FIGS. 12A to 12D illustrate a procedure for light emission control based on input image data. In forming an image, the light emission control unit 705 receives input image data IM1 in a binary bitmap format from the image data processing unit 703. In the diagram on the left in FIG. 12A, the j-th pixel value from the left in the i-th line from the top of the input image data IM1, which is a two-dimensional pixel value array, is represented as (j, i) (j={0, 1,2, . . . }, i={0, 1, 2, . . . }). The light emission control unit 705 adds dummy pixel values for (M-1) lines to the beginning of the input image data IM1. In a case of M=4, a range of an index i of the pixel value is {−3, −2, −1, 0, 1, 2, . . . } including the added dummy pixel values. The dummy pixel value may be, for example, zero, which means that the light emission is off. The light emission control unit 705 can add the dummy pixel values to the right and left of the input image data IM1 so that the number of the pixel values in one line is equal to the number of the light emitting elements in the axial direction. To provide a simplified explanation, only effective pixel values are illustrated in the axial direction.

In a first line cycle to of image formation, the light emission control unit 705 reads pixel values of the top four lines of the input image data IM1 and outputs a subset of every 2992 (=748*4) read pixel values to the light emitting chip 400-n via the signal line DATAn. Focusing on the light emitting chip 400-1 illustrated in a right diagram in FIG. 12A, during the line cycle t₀, the image data within a read range RD including pixel values from (0, −3) to (748, 0) is input via the signal line DATA1. The light emitting chip 400-1 performs serial-to-parallel conversion on the input image data and supplies driving signals based on these pixel values to each of the 2992 light emitting elements. For example, driving signals based on pixel values (0, −3), (0, −2), (0, −1), (0, 0) and (1, −3) are supplied to the light emitting elements R_{0_0}, R_{0_1}, R_{0_2}, R_{0_3}, and R_{1_0}. As indicated by a dashed line in FIG. 12A, a driving signal based on an effective pixel value of a line DL₀ with index i=0 of the input image data IM1 is supplied to the light emitting elements in the fourth row including the light emitting element R_{0_3}. Thus, a line L₀ on the surface of the photosensitive member 102 is exposed to light according to a pixel value set of the line DL₀ of the input image data IM1. At this point, multiple exposure is in progress, and formation of the line L₀ of the electrostatic latent image is not completed.

FIG. 12B illustrates driving of the light emitting chip 400-1 during the next line cycle t₀+1. In the line cycle t₀+1, the light emission control unit 705 moves the read range RD of the input image data IM1 down by one line, reads pixel values from (0, −2) to (748, 1), and outputs them to the light emitting chip 400-1 via the signal line DATA1. The light emitting chip 400-1 supplies driving signals based on these input pixel values to the 2992 light emitting elements. For example, driving signals based on pixel values (0, −2), (0, −1), (0, 0), (0, 1) and (1, −2) are supplied to the light emitting elements R_{0_0}, R_{0_1}, R_{0_2}, R_{0_3}, and R_{1_0}. In the line cycle to+1, the driving signal based on the effective pixel value in the line DL₀ of the input image data IM1 is supplied to the light emitting elements in the third row including the light emitting elements Ro_2. At this time, since the photosensitive member 102 rotates in the circumferential direction, the line L₀ on the surface of the photosensitive member 102 faces the light emitting elements in the third row of the light emitting chip 400-1. As a result, the line L₀ on the surface of the photosensitive member 102 is again exposed to light according to the pixel value set of the line DL₀ of the input image data IM1.

FIG. 12C illustrates driving of the light emitting chip 400-1 during the next line cycle t₀+2. In the line cycle t₀+2, the light emission control unit 705 moves the read range RD of the input image data IM1 further down by one line, reads pixel values from (0, −1) to (748, 2), and outputs them to the light emitting chip 400-1 via the signal line DATA1.

The light emitting chip 400-1 supplies driving signals based on these input pixel values to the 2992 light emitting elements. In the line cycle t₀+2, the driving signal based on the effective pixel value in the line DL₀ of the input image data IM1 is supplied to the light emitting elements in the second row including the light emitting element R_{0_1}. At this time, the line L₀ on the surface of the photosensitive member 102 faces the light emitting elements in the second row of the light emitting chip 400-1. As a result, the line L₀ on the surface of the photosensitive member 102 is exposed a third time to light according to the pixel value set of the line DL₀ of the input image data IM1.

FIG. 12D illustrates driving of the light emitting chip 400-1 during the next line cycle t₀+3. In the line cycle t₀+3, the light emission control unit 705 moves the read range RD of the input image data IM1 further down by one line, reads pixel values from (0, 0) to (748, 3), and outputs them to the light emitting chip 400-1 via the signal line DATA1. The light emitting chip 400-1 supplies driving signals based on these input pixel values to the 2992 light emitting elements. In the line cycle to+3, the driving signal based on the effective pixel value in the line DL₀ of the input image data IM1 is supplied to the light emitting elements in the first row including the light emitting element R_{0_0}. At this time, the line L₀ on the surface of the photosensitive member 102 faces the light emitting elements in the first row of the light emitting chip 400-1. As a result, the line L₀ on the surface of the photosensitive member 102 is exposed a fourth time to light according to the pixel value set of the line DL₀ of the input image data IM1. At this point, multiple exposure is performed by the four light emitting elements in each column of the light emitting chip 400, and the formation of the line L₀ of the electrostatic latent image is completed. A line subsequent to the line L₀ of the electrostatic latent image can be similarly formed on the surface of the photosensitive member 102 through the repetition of the above-described line cycles. In this way, according to the present exemplary embodiment, pixel values from (0, 0) to (748, 3) are input to the four light emitting elements. For example, a pixel value of (0, 0) is input to the four light emitting elements R_{0_0}, R_{0_1}, R_{0_2}, and R_{0_3}. Further, for example, a pixel value of (1, 0) is input to the four light emitting elements R_{1_0}, R_{1_1}, R_{1_2}, and R_{1_3}. In other words, a spot on the photosensitive member 102 corresponding to the pixel value of (0, 0) is formed by the four light emitting elements R_{0_0}, R_{0_1}, R_{0_2}, and R_{0_3}, and a spot on the photosensitive member 102 corresponding to the pixel value of (1, 0) is formed by the four light emitting elements R_{1_0}, R_{1_1}, R_{1_2}, and R_{1_3}.

As can be understood from the above description, the light emission control unit 705 causes the plurality of light emitting elements 602 to emit light based on the pixel value read from a read range over M lines of the input image data IM1. The read range is moved by one line per line cycle. The control of the read range as described above is also performed in a similar manner in compensation of a positional deviation.

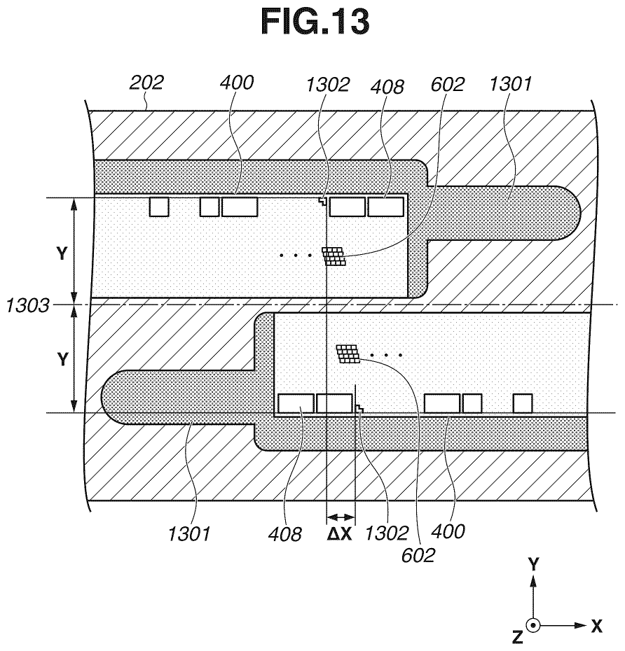

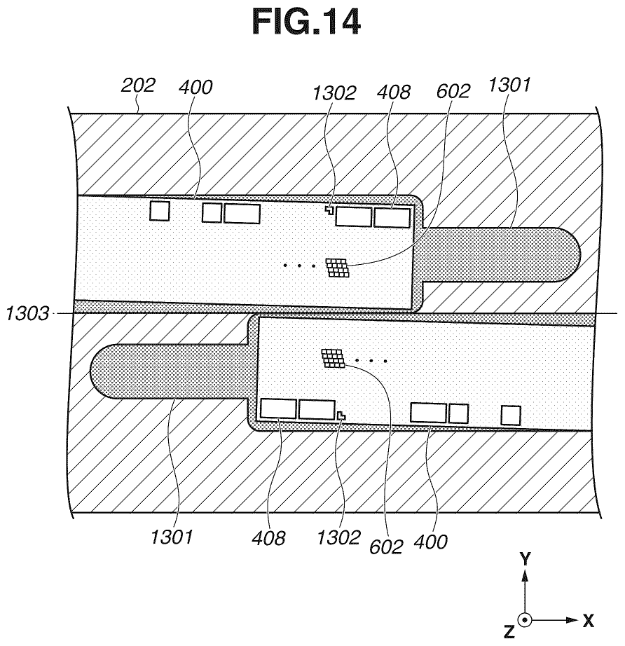

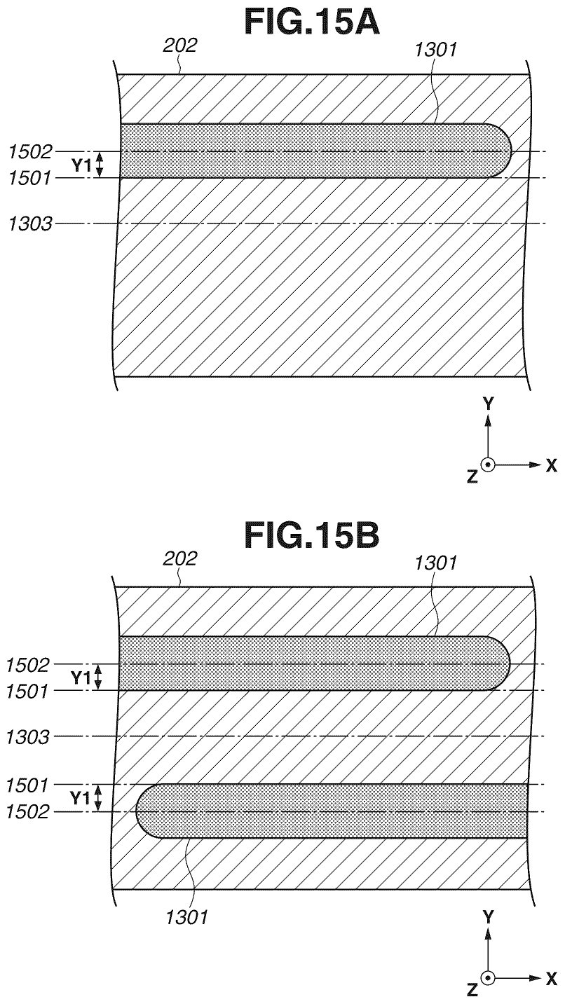

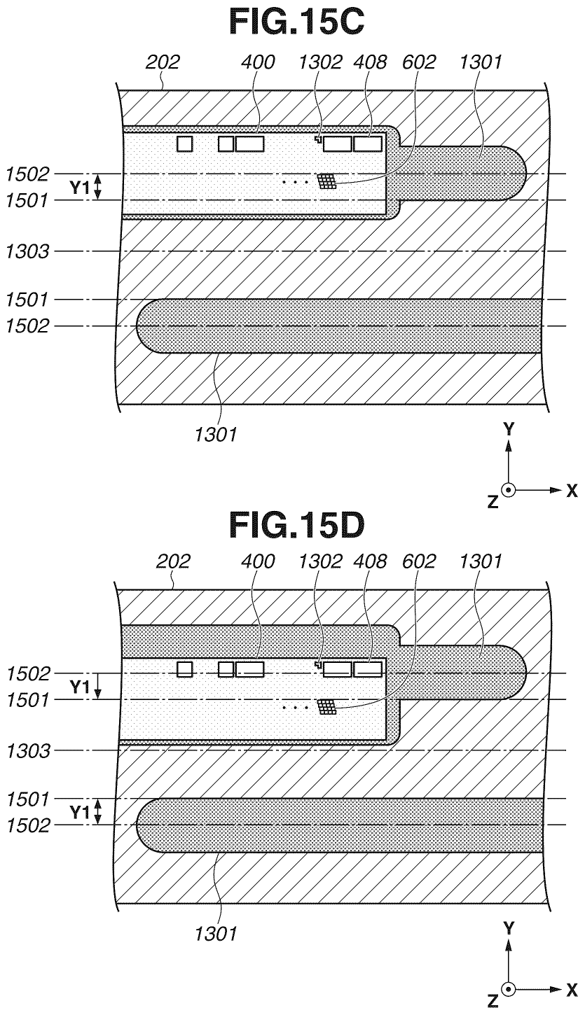

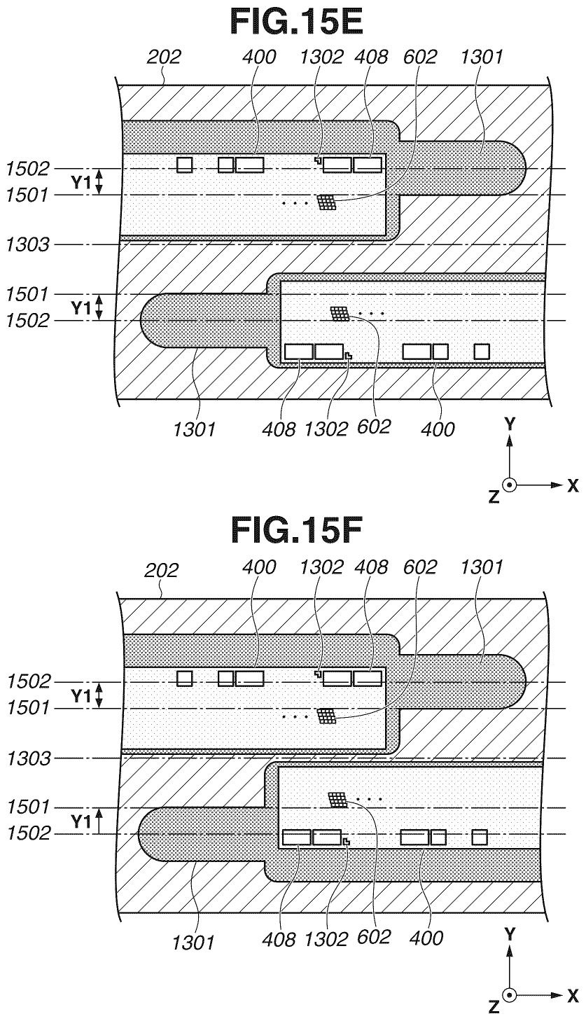

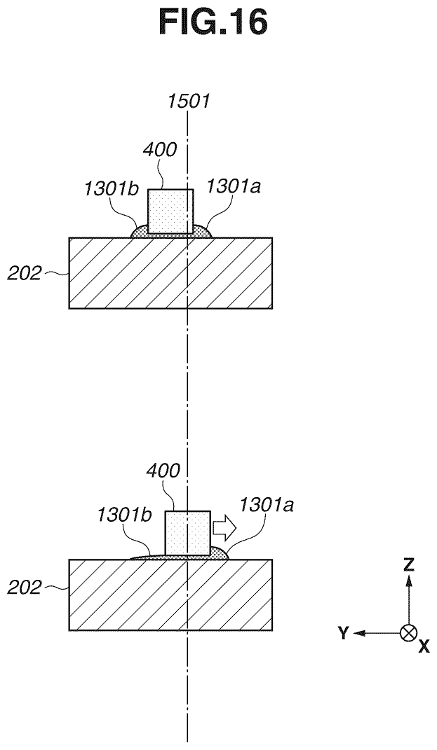

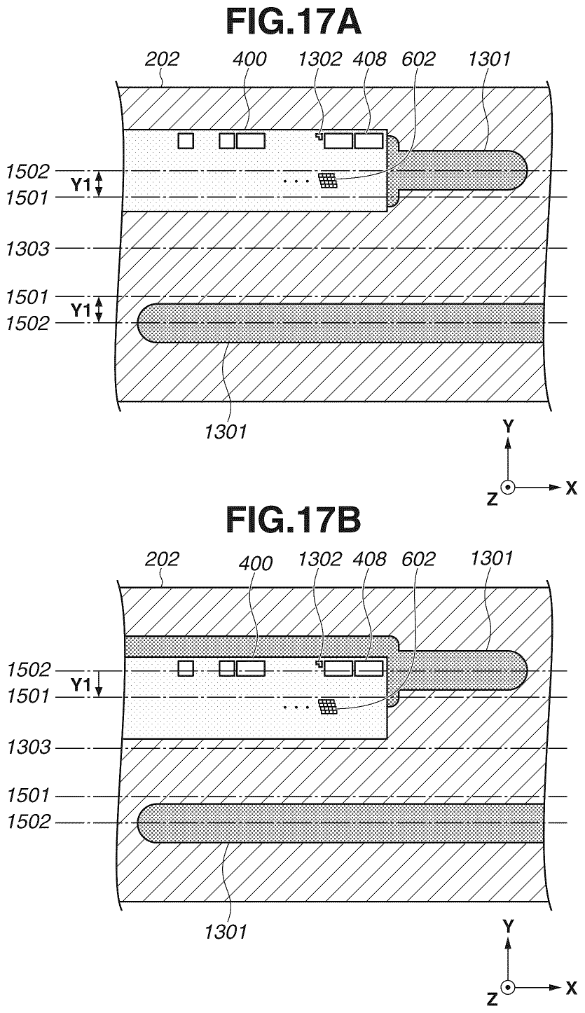

A first exemplary embodiment according to the present disclosure is described below with reference to FIGS. 13 to 17B. FIG. 13 is a plan view illustrating a schematic configuration of the light emitting chip 400 with respect to the printed substrate 202. FIG. 14 is a plan view illustrating an outline of a case where an attachment position of the light emitting chip 400 is deviated from a design value with respect to the printed substrate 202. FIGS. 15A to 15F are plan views illustrating a die bonding process according to the first exemplary embodiment. FIG. 16 is cross-sectional views of the die bonding process according to the first exemplary embodiment. FIGS. 17A and 17B are plan views illustrating the die bonding process in a case where an amount of applied adhesive is small according to the first exemplary embodiment.

As illustrated in FIG. 13, the light emitting chips 400 are arranged in a staggered pattern on the printed substrate 202 along a reference line 1303 extending in a longitudinal direction of the printed substrate 202. An adhesive 1301 is applied in a staggered pattern on the surface of the printed substrate 202 corresponding to the light emitting chips 400. Each of the light emitting chips 400 is bonded to the printed substrate 202 by the adhesive 1301 arranged in the staggered pattern, as further described below.

In a case where a plurality of light emitting chips 400 are mounted on the printed substrate 202, there is a risk that a mounting position of each light emitting chip 400 may deviate from a design value. Particularly, in a case where the light emitting chips 400 adjacent to each other in the longitudinal direction of the printed substrate 202 are mounted with a deviation in a direction away from each other, there is a risk that the photosensitive member 102 is not exposed to light in an area between the light emitting chips 400. Therefore, according to the present exemplary embodiment, a configuration is provided in which the light emitting chips 400 are arranged in a staggered pattern, and end portions of the adjacent light emitting chips 400 overlap each other in the longitudinal direction of the printed substrate 202. With the configuration in which the end portions of the light emitting chips 400 overlap each other in the longitudinal direction and the light emitting elements 602 included in the light emitting chips 400 also overlap, it is possible to reduce a risk that an area where the photosensitive member 102 is not exposed to light is generated at a boundary between the adjacent light emitting chips 400, even if the mounting position of the light emitting chip 400 deviates from a design value.

According to the present exemplary embodiment, the rod lens array in which a plurality of rod lenses is arranged in two columns along the longitudinal direction of the printed substrate 202 is used to collect the light emitted by the light emitting elements 602. At this time, light collection efficiency is increased by locating the light emitting elements 602 as close as possible to the rod lenses arranged in two columns in a transverse direction of the printed substrate 202. Thus, the light collection efficiency of the rod lens array should match a center line of the two columns of rod lenses and a center line of the light emitting chips 400 arranged in the staggered pattern and arrange each of the light emitting chips 400 as close to the center line as possible. Therefore, accurate mounting of the light emitting chips 400 in a state in which they are close to the center line reduces a risk of a decrease in the light collection efficiency of the rod lens array.

According to the present exemplary embodiment, each of the light emitting chips 400 is die-bonded so that a position of a chip alignment mark 1302 present in the light emitting chip 400 falls within a predetermined range with respect to a target position. The mounting position of the light emitting chip 400, which is a first chip located at an outermost position of the printed substrate 202 in an X direction, is determined based on a predetermined position of the printed substrate 202. Meanwhile, a second chip adjacent to the first chip in the X direction and subsequent chips are relatively positioned so that a distance AX between the chip alignment marks 1302 of the adjacent light emitting chips 400 falls within the predetermined range. Regarding accuracy of the mounting position in a Y direction, the mounting position of the light emitting chip 400 is determined so that a distance Y from the reference line 1303 to the chip alignment mark 1302 falls within the predetermined range. Since two chip alignment marks 1302 are provided at the end portions of the light emitting chip 400 in the longitudinal direction (X direction), both chip alignment marks 1302 are set to fall within a predetermined Y range. By using the two chip alignment marks 1302, a mounting angle θ of the light emitting chip 400 may be calculated with respect to the reference line 1303. In a case where the distance Y of the chip alignment mark 1302 on one side is deviated, the angle θ of the light emitting chip 400 is adjusted so that the both chip alignment marks 1302 fall within the predetermined Y range.

In order to satisfy the above-described need for accuracy, after the light emitting chip 400 is landed on the printed substrate 202, the position of the chip alignment mark 1302 is confirmed by a camera. If it deviates from the predetermined range, the position of the light emitting chip 400 is corrected and a post-landing correction operation is performed to correct XYθ positions.

According to the present exemplary embodiment, an amount of the adhesive 1301 is applied to bond the light emitting chip 400, in a quantity sufficient to securely bond the light emitting chip 400 to the printed substrate 202. At this time, if the light emitting chip 400 is mounted, the adhesive 1301 may protrude outside the light emitting chip 400. FIG. 14 illustrates a case where the adhesive 1301 protrudes outside the light emitting chip 400. As illustrated in FIG. 14, if the adhesive 1301 protrudes outside the light emitting chip 400, the adhesive 1301 may come into contact with the light emitting chips 400 that are arranged in the staggered pattern, adjacently positioned on opposite sides of the center line. At this time, there is concern that the adhesive 1301 in contact with the light emitting chip 400 cures and shrinks, causing deviation in accuracy of the light emitting chip 400 after die bonding.

On the other hand, if the amount of adhesive to be applied is reduced to avoid contact of the adhesive 1301 described above, the adhesive 1301 does not spread to an outer periphery of the light emitting chip 400, and there is concern for reduction of adhesive strength or the light emitting chip 400 peeling off starting from the outer periphery. Further, the pad 408 is present on a chip end opposite to a side where the first and second columns of the light emitting chips 400 in a staggered arrangement face each other. In a case where the printed substrate 202 and the light emitting chip 400 are electrically connected by wire bonding, if the amount of the adhesive 1301 to be applied is small, a space under the chip of the pad 408 is not filled with the adhesive 1301 and will be hollow. Accordingly, there is also a concern that an ultrasonic force may not be transmitted and stability of wire bonding may be reduced.

According to the present exemplary embodiment, as illustrated in FIG. 13, it is configured so that an amount of the adhesive 1301 protruding from the light emitting chip 400 is greater on the opposite side than on the side where the first and second columns of the light emitting chips 400 in the staggered arrangement face each other. With this configuration, between the first and second columns of the light emitting chips 400 in the staggered arrangement, the protruding amount of the adhesive 1301 is small, thereby reducing a possibility of deviation in accuracy of the light emitting chip 400 due to contact with the adhesive 1301. On the side opposite to the side where the first and second columns of the light emitting chips 400 in the staggered arrangement face each other, the protruding amount of the adhesive 1301 is large, and the space under the chip is filled with the adhesive 1301. As a result, the light emitting chip 400 and the printed substrate 202 are securely bonded to each other, and the risk of the light emitting chip 400 peeling off can be reduced. Further, the space under the pad 408 is also filled with the adhesive 1301. This also leads to improved stability of wire bonding.

Next, a die bonding process for realizing a protruding configuration of the adhesive 1301 according to the present exemplary embodiment is described.

The adhesive 1301 is applied to bond the printed substrate 202 and the light emitting chip 400. The adhesive 1301 is applied in a staggered arrangement at a position corresponding to each of the light emitting chips 400. More specifically, the adhesive 1301 is applied on a first column side of the staggered arrangement in the positive direction in the X direction, as illustrated in FIG. 15A, and is then applied on a second column side of the staggered arrangement in the negative direction in the X direction, as illustrated in FIG. 15B. The adhesive 1301 may be applied on all the first column sides of the staggered arrangement corresponding to the number of the light emitting chips 400 and then applied on the second column sides. Further, the adhesive 1301 may be applied alternately in such a manner: on the first column side, the second column side, and the first column side.

A virtual line 1501 is a reference position for die bonding and is also a line that is the center of the light emitting chip 400 to be mounted. A virtual line 1502 is illustrated at a position offset by a distance Y1 in a direction away from the virtual line 1501 between the first and second columns in the staggered arrangement. The adhesive 1301 is applied with the virtual line 1502 as a reference for the position in the Y direction.

Next, the light emitting chip 400 is die bonded onto the printed substrate 202. Die bonding is performed in the staggered arrangement on one chip for every adhesive 1301. As described above, the mounting positions of the adjacent light emitting chips 400 need to be relatively determined so as to fall within a predetermined range. Thus, die bonding is performed alternately on the first column side, the second column side, and then the first column side.

Regarding die bonding on the first column side, FIG. 15C illustrates a case where the light emitting chip 400 is mounted on the printed substrate 202. The position in the Y direction in a case where the light emitting chip 400 is landed on the printed substrate 202 is determined based on the virtual line 1502, as in the case where the adhesive 1301 is applied to the printed substrate 202. In other words, die bonding is performed targeting a position where the center of the area to which the adhesive 1301 is applied overlaps with the center of the light emitting chip 400 in the Y direction. In a case where die bonding is performed, the light emitting chip 400 is bonded in a state where an appropriate load is applied thereto, so that no cavity is formed between the light emitting chip 400 and the printed substrate 202.

As described above, the virtual line 1501 is the target for the final mounting position of the light emitting chip 400. According to the present exemplary embodiment, the light emitting chip 400 is landed on the printed substrate 202 with the virtual line 1502 as the target as illustrated in FIG. 15D. The virtual lines 1501 and 1502 are separated by the distance Y1 in the Y direction. Then, a Y direction approaching operation is performed to move the light emitting chip 400 landed on the printed substrate 202 in the Y direction by the distance Y1 toward the virtual line 1501. FIG. 15E is a plan view illustrating the die bonding process according to the exemplary embodiment. FIG. 15F is a plan view illustrating the die bonding process according to the exemplary embodiment.

In a case where the position of the light emitting chip 400 is not within the predetermined range after the Y direction approaching operation, the above-described XYθ post-landing correction operation is performed.

On the second column side, the light emitting chip 400 is landed on the printed substrate 202 targeting the virtual line 1502 in the same manner as on the first column side. Then, the Y direction approaching operation is performed to move the light emitting chip 400 in the Y direction by the distance Y1 toward the virtual line 1501, which is the target of the final mounting position. In a case where the position of the light emitting chip 400 is not within the predetermined range after the Y direction approaching operation, the XY0 post-landing correction operation is performed, as described herein.

By the above-described die bonding process, each of the light emitting chips 400 in the first and second columns in the staggered arrangement is mounted in a state where it is brought close to the reference line 1303 by the Y direction approaching operation. At this time, an amount of the adhesive 1301 that protrudes outside the light emitting chip 400 in a case where the light emitting chip 400 is bonded to the adhesive 1301 applied to the printed substrate 202 is defined as the protruding amount. Since a protruding portion of the adhesive 1301 is located outside the light emitting chip 400, the light emitting chip 400 and a protruding area of the adhesive 1301 do not overlap with each other, viewed from a direction perpendicular to a surface of the printed substrate 202.

In the Y direction of long sides of the light emitting chip 400, the long side that is farther from the reference line 1303 is brought closer to the center where the adhesive 1301 is applied. On the other hand, the long side of the light emitting chip 400 closer to the reference line 1303 is farther away from the center where the adhesive 1301 is applied. Thus, if the amount of the adhesive 1301 protruding from the light emitting chip 400 on the side opposite to the reference line 1303 in the Y direction is compared with the amount of the adhesive 1301 protruding on the side where the first and second columns of the light emitting chips 400 in the staggered arrangement face each other, the former protruding amount is greater. An area where the adhesive 1301 protruding from the light emitting chip 400 on the side opposite to the reference line 1303 in the Y direction is applied is defined as a first protruding area, and an area where the adhesive 1301 protruding on the side where the first and second columns of the light emitting chips 400 in the staggered arrangement face each other is applied is defined as a second protruding area. As described above, if an area of the first protruding area is compared with an area of the second protruding area, the area of the first protruding area is larger. In other words, if the first protruding area located on one side of the light emitting chip 400 is compared with the second protruding area located on the other side thereof in the transverse direction of the printed substrate 202, the area of the first protruding area is larger than the area of the second protruding area.

Next, a length of the adhesive 1301 applied to the printed substrate 202 in the X direction is described. According to the present exemplary embodiment, if the length of the adhesive 1301 applied to the printed substrate 202 is compared with a length of the light emitting chip 400 in the X direction, the adhesive 1301 is longer. In other words, the adhesive 1301 is applied to the printed substrate 202 in the X direction with a length that is greater than the length of the light emitting chip 400 in the X direction. This is to securely bond the light emitting chip 400 to the printed substrate 202. The adhesive 1301 is applied with the length greater than the length of the light emitting chip 400 in the X direction, so that it is possible to securely bond the end portion of the light emitting chip 400 in the X direction to the printed substrate 202 and reduce the risk of the light emitting chip 400 peeling off from the printed substrate 202. According to the present exemplary embodiment, the adhesive 1301 is applied to the printed substrate 202 over an area that is greater than the length of the light emitting chip 400 in the X direction, but an application area of the adhesive 1301 may be shorter than the length of the light emitting chip 400 if sufficient adhesive strength can be secured.

Next, a difference in the amount of the adhesive 1301 to be applied is described. Although the adhesive 1301 is applied at a position separated from a die bonding target position, as greater amounts are applied, a possibility that the adhesive 1301 comes into contact with the light emitting chips 400 in the first and second columns in the staggered arrangement increases after the Y direction approaching operation.

As illustrated in FIG. 16, adhesives 1301a and 1301b that protrude in landing the light emitting chip 400 on the printed substrate 202 are absorbed into the space under the chip during the Y direction approaching operation. During the approaching operation, a large percentage of the adhesive 1301 is absorbed. The adhesive 1301b protrudes to a side opposite to the Y direction approaching operation. That is, the adhesive 1301b forms on the side opposite to the side where the first and second columns of the light emitting chips 400 in the staggered arrangement face each other. The adhesive 1301a that protrudes to the side where the first and second columns of the light emitting chips 400 in the staggered arrangement face each other is also adsorbed into the space under the chip during the Y direction approaching operation, as the protruding portion is dragged. Thus, if the protruding amount in landing the chip is excessively large, the adhesive 1301 may come into contact with the light emitting chips 400 in the first and second columns in the staggered arrangement after the Y direction approaching operation. Accordingly, the amount of the adhesive 1301 to be applied is suppressed to an extent that the adhesive 1301 does not come into contact with the light emitting chips 400 in the first and second columns in the staggered arrangement after the Y direction approaching operation.

Described below is a case where a small amount of the adhesive 1301 is to be applied. In a case where the light emitting chip 400 is landed on the printed substrate 202 as illustrated in FIG. 17A, the amount of the adhesive 1301 protruding from the light emitting chip 400 is reduced. In this state, the adhesive 1301 does not spread to the outer periphery of the light emitting chip 400, which may cause concerns about peeling and stability of wire bonding, as described above. However, as illustrated in FIG. 17B, by performing the Y direction approaching operation, the light emitting chip 400 slides on the adhesive 1301, and the side opposite to the side where the first and second columns of the light emitting chips 400 in the staggered arrangement face each other is moved toward the center of the applied adhesive, thereby filling the space under the chip with the adhesive 1301. Although the entire space under the chip is not filled with the adhesive 1301, the possibility of peeling starting from the outer periphery is reduced, as compared with a state illustrated in FIG. 17A in which two outer periphery sides of the light emitting chip 400 are not filled with the adhesive 1301. Further, since the space under the chip of the pad 408 is filled with the adhesive 1301, the stability of wire bonding is improved. There is little protrusion in landing of the chip, and thus there is no concern for dragging the adhesive 1301a protruded during the Y direction approaching operation on the side where the first and second columns of the light emitting chips 400 in the staggered arrangement face each other, effectively reducing the possibility of the adhesive 1301 coming into contact with the light emitting chips 400 in the first and second columns in the staggered arrangement.

In this way, the amount of the adhesive 1301 to be applied is suppressed to an extent that the adhesive 1301 does not come into contact with the light emitting chips 400 in the first and second columns in the staggered arrangement after the Y direction approaching operation and is set within an application range in which the side opposite to the side where the first and second columns of the light emitting chips 400 in the staggered arrangement face each other securely reaches the area of the adhesive 1301 after the Y direction approaching operation. The amount of the adhesive 1301 to be applied is determined by a relationship between the Y direction width and Y direction approaching amount of the light emitting chip 400, physical properties of the adhesive 1301, and the Y direction width after squeezing. Thus, the amount of the adhesive 1301 to be applied is to be appropriately adjusted according to a situation.

As described above, according to the present exemplary embodiment, the adhesive 1301 is applied at a position separated from the die bonding target position, the light emitting chip 400 is landed, and the Y direction approaching operation is performed after landing.

Accordingly, the amount of the adhesive 1301 protruding from the light emitting chip 400 is greater on the opposite side than on the side where the first and second columns of the light emitting chips 400 in the staggered arrangement face each other. Therefore, the protruding amount of the adhesive 1301 is small between the light emitting chips 400 in the first and second columns in the staggered arrangement, thereby reducing the possibility of deviation in accuracy of the light emitting chip 400 due to contact with the adhesive 1301. In addition, the protruding amount of the adhesive 1301 is large on the side opposite to the side where the first and second columns of the light emitting chips 400 in the staggered arrangement face each other, and the space under the chip is filled with the adhesive 1301, thereby improving adhesive strength between the light emitting chip 400 and the printed substrate 202 and suppressing peel-off of the light emitting chip 400 starting from the outer periphery. Further, the space under the chip of the pad 408 is similarly filled with the adhesive 1301, which leads to improved wire bonding stability.

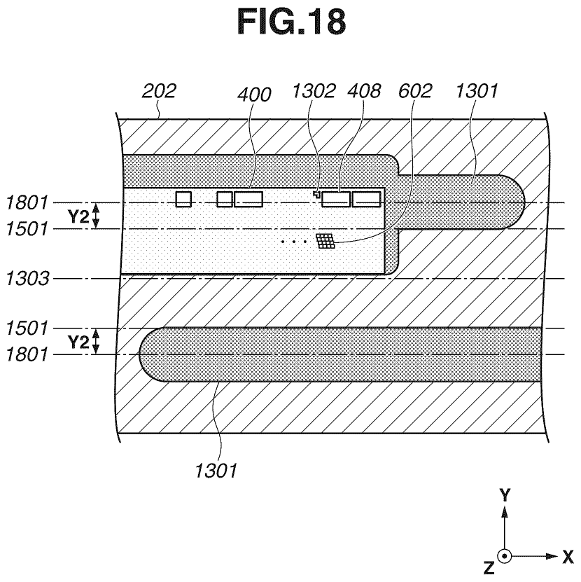

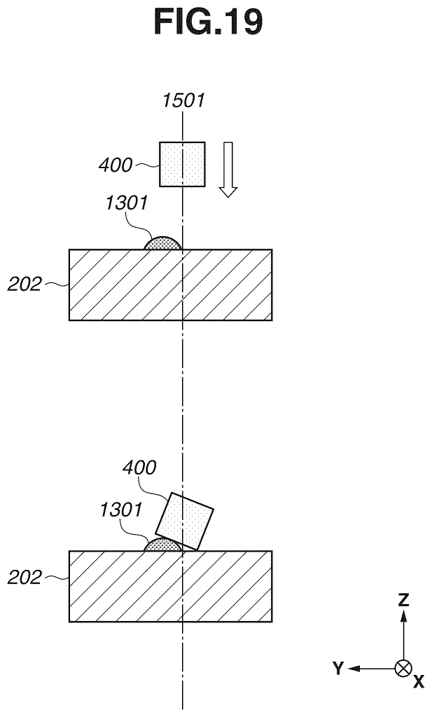

A second exemplary embodiment according to the present disclosure is described below with reference to FIGS. 18 and 19. FIG. 18 is a plan view illustrating a die bonding process according to the second exemplary embodiment. FIG. 19 is a cross-sectional view of the die bonding process according to the second exemplary embodiment. According to the present exemplary embodiment, the die bonding process is different from the first exemplary embodiment, so that only different points are described.

As illustrated in FIG. 18, a Y position of the adhesive 1301 is on a virtual line 1801 at a position offset by a distance Y2 in a direction away from the first and second columns in the staggered arrangement with respect to the virtual line 1501 that is the center of the light emitting chip 400 at the die bonding target position. Regarding a Y position of the light emitting chip 400, die bonding is performed so that the center of the light emitting chip 400 overlaps with the virtual line 1501, i.e., the die bonding target position. Thus, die bonding is performed by shifting the application center of the adhesive 1301 and the center of the light emitting chip 400. If the position of the light emitting chip 400 is not within the predetermined range, the XYθ post-landing correction operation is performed, as described above.

In the present configuration, the application center of the adhesive 1301 in die bonding is shifted from the center of the light emitting chip 400. Thus, there is concern that if the light emitting chip 400 lands on the printed substrate 202, the light emitting chip 400 may tilt due to a reaction force of the adhesive 1301, as illustrated in FIG. 19. If the light emitting chip 400 tilts, the chip alignment mark 1302 may not be recognized, and the post-landing correction operation may not be possible. Since the adhesive 1301 is not squeezed, there is a possibility that the adhesive 1301 gradually penetrates after die bonding, and a force of the adhesive 1301 may cause deviation in accuracy of the light emitting chip 400. Therefore, according to the present exemplary embodiment, there is concern that an issue in accuracy may occur compared with the first exemplary embodiment. However, there is an advantage of simplifying the process since the Y direction approaching operation does not need to be performed.

As described above, according to the present exemplary embodiment, the adhesive 1301 is applied to a position offset in a direction away from the first and second columns in the staggered arrangement with respect to the die bonding target position. Accordingly, the amount of the adhesive 1301 protruding from the light emitting chip 400 is greater on the opposite side than on the side where the first and second columns of the light emitting chips 400 in the staggered arrangement face each other. Therefore, the protruding amount of the adhesive 1301 is small between the light emitting chips 400 in the first and second columns in the staggered arrangement, thereby reducing the possibility of deviation in accuracy of the light emitting chip 400 due to contact with the adhesive 1301. In addition, the protruding amount of the adhesive 1301 is large on the side opposite to the side where the first and second columns of the light emitting chips 400 in the staggered arrangement face each other, and the space under the chip is filled with the adhesive 1301, thereby improving adhesive strength between the light emitting chip 400 and the printed substrate 202 and suppressing peel-off of the light emitting chip 400 starting from the outer periphery. Further, the space under the chip of the pad 408 is similarly filled with the adhesive 1301, which leads to improved wire bonding stability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-088425, filed May 30, 2024, which is incorporated herein by reference in its entirety.

What is claimed is:

1. An exposure head comprising:
a light emitting chip including a plurality of light emitting elements configured to emit light for exposing a photosensitive member and arranged along a direction of a rotation axis of the photosensitive member;
a substrate configured to mount the light emitting elements; and
an adhesive configured to bond the substrate and the light emitting chip,
wherein, with the adhesive applied to a surface of the substrate, a protruding area of the adhesive does not overlap with the light emitting chip, viewed from a direction perpendicular to the surface of the substrate,
wherein the protruding area includes a first protruding area located on one side of the light emitting chip and a second protruding area located on an opposite side of the light emitting chip in a transverse direction of the substrate, and
wherein the first protruding area is larger than the second protruding area.

2. The exposure head according to claim 1, further comprising:
a plurality of the light emitting chips included in the exposure head,
wherein the plurality of the light emitting chips are arranged in a staggered pattern along a longitudinal direction of the substrate.

3. The exposure head according to claim 2,
wherein the staggered pattern of the plurality of the light emitting chips is centered on a reference line along the longitudinal direction of the substrate, and
wherein a distance between the first protruding area and the reference line is greater than a distance between the second protruding area and the reference line in the transverse direction.

4. An image forming apparatus comprising:
a photosensitive member; and
the exposure head according to claim 1.

5. The exposure head according to claim 1, wherein the plurality of light emitting elements are organic electroluminescence (EL) elements.

6. An exposure head comprising:
a light emitting chip including a plurality of light emitting elements configured to emit light for exposing a photosensitive member and arranged along a direction of a rotation axis of the photosensitive member;
a substrate configured to mount the light emitting elements; and
an adhesive configured to bond the substrate and the light emitting chip,
wherein, with the adhesive applied to a surface of the substrate, a protruding area of the adhesive does not overlap with the light emitting chip, viewed from a direction perpendicular to the surface of the substrate, and
wherein at least a part of the protruding area is located on one side of the light emitting chip and is not located on an opposite side of the light emitting chip in a transverse direction of the light emitting chip.

7. The exposure head according to claim 6, further comprising:
a plurality of the light emitting chips included in the exposure head,
wherein the plurality of the light emitting chips are arranged in a staggered pattern along a longitudinal direction of the substrate.

8. An image forming apparatus comprising:
a photosensitive member; and
the exposure head according to claim 6.

9. The exposure head according to claim 6, wherein the plurality of light emitting elements are organic electroluminescence (EL) elements.

10. A method for manufacture of an image forming apparatus that includes an exposure head, which includes a substrate and a light emitting chip with a plurality of light emitting elements configured to emit light for exposing a photosensitive member, the method comprising:
mounting the light emitting elements on the substrate; and
bonding, utilizing an adhesive, the substrate and the light emitting chip,
wherein, with the adhesive applied to a surface of the substrate, a protruding area of the adhesive does not overlap with the light emitting chip, viewed from a direction perpendicular to the surface of the substrate.

11. The method for manufacture of claim 10,
wherein the protruding area includes a first protruding area located on one side of the light emitting chip and a second protruding area located on an opposite side of the light emitting chip in a transverse direction of the substrate, and
wherein the first protruding area is larger than the second protruding area.

12. The method for manufacture of claim 10,
wherein the plurality of light emitting elements are arranged along a direction of a rotation axis of the photosensitive member.

13. The method for manufacture of claim 12,
wherein a plurality of the light emitting chips are included in the exposure head, with the plurality of the light emitting chips arranged in a staggered pattern along a longitudinal direction of the substrate.

14. The method for manufacture of claim 13,
wherein the staggered pattern of the plurality of the light emitting chips is centered on a reference line along the longitudinal direction of the substrate, and
wherein a distance between the first protruding area and the reference line is greater than a distance between the second protruding area and the reference line in the transverse direction.
